(19) United States
(12) Patent Application Publication
(10) Pub. No.: US 2020/0160853 A1
(43) Pub. Date: May 21, 2020

(54) NON-TRANSITORY COMPUTER-READABLE STORAGE MEDIUM FOR STORING NOISE SUPPRESSION PROGRAM, NOISE SUPPRESSION METHOD, AND NOISE SUPPRESSION APPARATUS

(71) Applicant: FUJITSU LIMITED, Kawasaki-shi (JP)

(72) Inventors: Yohei KISHI, Kawasaki (JP); akira kamano, Kawasaki (JP); Chisato Shioda, Sagamihara (JP); Nobuyuki WASHIO, Akashi (JP); Masanao SUZUKI, Yokohama (JP)

(73) Assignee: FUJITSU LIMITED, Kawasaki-shi (JP)

(21) Appl. No.: 16/597,226

(22) Filed: Oct. 9, 2019

(30) Foreign Application Priority Data
Nov. 16, 2018 (JP) 2018-216027

(51) Int. Cl. G10L 15/20; G10L 25/84; G10L 21/0232; G10L 15/22; G10L 25/21

(52) U.S. Cl. CPC G10L 15/20; G10L 25/84; G10L 25/21; G10L 15/22; G10L 21/0232

(57) ABSTRACT

A noise suppression method performed by a computer includes: obtaining input sound; detecting a cycle of power change in a non-voice segment included in the input sound; calculating a correction amount that periodically changes and is applied to a voice segment included in the input sound based on the cycle; and correcting power in at least the voice segment based on the correction amount.

### CROSS-REFERENCE TO RELATED APPLICATION

This application is based upon and claims the benefit of priority of the prior Japanese Patent Application No, 2018-216027, filed on Nov. 16, 2018, the entire contents of which are incorporated herein by reference.

### FIELD

The embodiments discussed herein are related to a non-transitory computer-readable storage medium storing a noise suppression program, a noise suppression method, and a noise suppression apparatus.

### BACKGROUND

Voice recognition is used in wide-ranging fields represented by voice-to-text conversion, that is so-called dictation, and also voice assistant, voice translation, and the like which are mounted to smart phones and smart speakers. For example, in a case where voice recognition is performed, noise included in input sound may be a factor for a decrease in a recognition rate in some cases.

An example of a technology for suppressing such noise includes the following noise removal system. In this noise removal system, a short-time spectrum is calculated by performing Fourier transform of a frame signal cut out from an input signal. A noise spectrum is estimated from the short-time spectrum in a silence segment in the noise removal system. In the noise removal system, after a start point of voice is detected, a value obtained by multiplying the noise spectrum estimated in the last silence segment by a spectrum subtraction coefficient is subtracted from the short-time spectrum to perform noise removal.

Examples of the related art include Japanese Laid-open Patent Publication Nos. 2015-170988, 2015-177447, and 8-221092.

### SUMMARY

According to an aspect of the embodiments, a noise suppression method performed by a computer includes: obtaining input sound; detecting a cycle of power change in a non-voice segment included in the input sound; calculating a correction amount that periodically changes and is applied to a voice segment included in the input sound based on the cycle; and correcting power in at least the voice segment based on the correction amount.

The object and advantages of the invention will be realized and attained by means of the elements and combinations particularly pointed out in the claims.

It is to be understood that, both the foregoing general description and the following detailed description are exemplary and explanatory and are not restrictive of the invention.

### BRIEF DESCRIPTION OF DRAWINGS

FIG. 1 is a block diagram illustrating an example of a functional configuration of a noise suppression apparatus according to a first embodiment;

FIG. 2A is a diagram illustrating an example of a spectrum of stationary noise;

FIG. 2B is a diagram illustrating an example of a spectrum of periodic noise;

FIG. 3A is a diagram illustrating an example of a temporal waveform of input sound;

FIG. 3B is a diagram illustrating an example of a temporal waveform of output sound;

FIG. 4 is a diagram illustrating an example of the temporal waveform of the input sound;

FIG. 5 is a diagram illustrating an example of the temporal waveform of the output sound;

FIG. 6A is a diagram illustrating an example of a temporal waveform of voice;

FIG. 6B is a diagram illustrating an example of a temporal waveform including the periodic noise and the voice;

FIG. 6C is a diagram illustrating an example of a temporal waveform of output sound after suppression of the periodic noise;

FIG. 7 is a diagram illustrating an example of a functional configuration of a periodic noise determination unit;

FIG. 8A is a diagram illustrating an example of a temporal waveform in a specific frequency band;

FIG. 8B is a diagram illustrating an example of a temporal waveform of an envelope;

FIG. 8C is a diagram illustrating an example of a power spectrum;

FIG. 9 is a diagram illustrating an example of a functional configuration of a periodic noise estimation unit;

FIG. 10 is a diagram illustrating an example of a phase correction method;

FIG. 11 is a diagram illustrating an example of the phase correction method;

FIG. 12 is a flowchart illustrating a procedure of noise suppression processing according to the first embodiment;

FIG. 13 is a flowchart illustrating a procedure of periodic noise determination processing according to the first embodiment;

FIG. 14 is a flowchart illustrating a procedure of periodic noise estimation processing according to the first embodiment; and

FIG. 15 is a diagram illustrating a hardware configuration example of a computer configured to execute a noise suppression program according to first and second embodiments.

### DESCRIPTION OF EMBODIMENT(S)

However, according to the above-mentioned technology, it is difficult to suppress periodic noise where power periodically changes.

According to one aspect, the present disclosure aims at providing a noise suppression program with which periodic noise included in input sound may be suppressed, a noise suppression method, and a noise suppression apparatus.

Hereinafter, a noise suppression program, a noise suppression method, and a noise suppression apparatus according to the present application are described with reference to the accompanying drawings. The embodiment discussed herein are not intended to limit the technology of the disclosure. The embodiments may be appropriately combined within a range where processing contents are not conflicted.

### First Embodiment

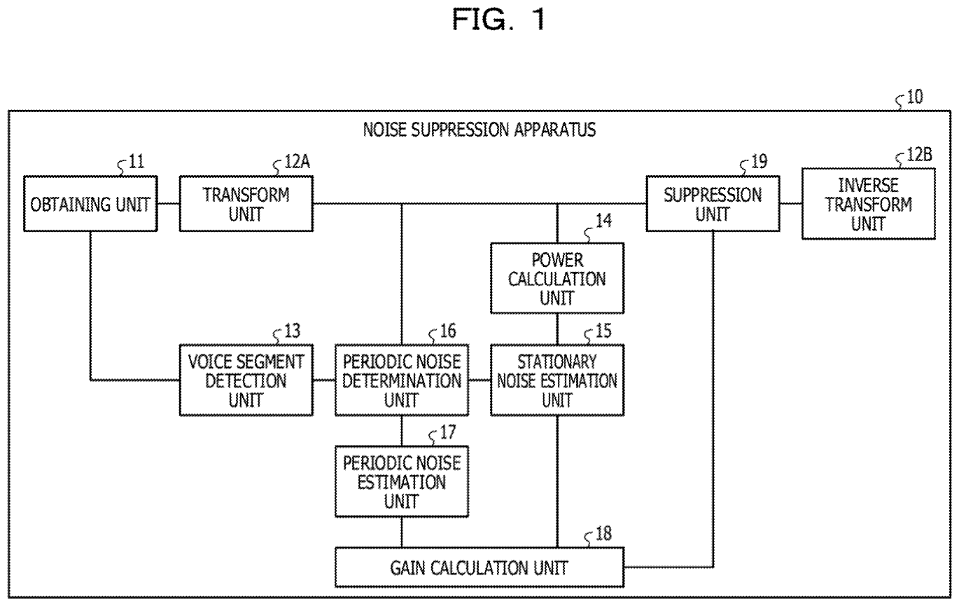

FIG. 1 is a block diagram illustrating an example of a functional configuration of a noise suppression apparatus according to a first embodiment. A noise suppression apparatus 10 illustrated in FIG. 1 is configured to realize a noise suppression function for suppressing noise included in input sound. As part of this noise suppression function, the noise suppression apparatus 10 suppresses periodic noise where power periodically changes among noise included in the input sound.

[Stationary Noise and Periodic Noise]

“Stationary noise” where a power level does not change may be superimposed over voice in some cases. For example, sound such as rotating sound of a fan or motor and hum noise of a machine are exemplified as the stationary noise. “Periodic noise” where power periodically changes may be superimposed over the voice in addition to the above-mentioned the stationary noise. For example, noise having a cycle longer than a frame length at which a voice signal is divided such as, for example, operating sound of an air conditioner or the like corresponds to the periodic noise.

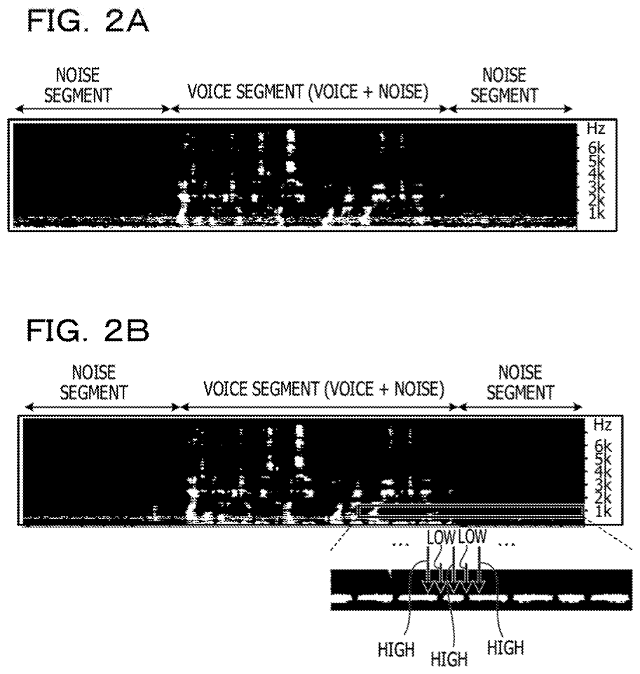

Points of similarity and difference of these stationary noise and periodic noise will be described. FIG. 2A is a diagram illustrating an example of a spectrum of the stationary noise. FIG. 2B is a diagram illustrating an example of a spectrum of the periodic noise. The vertical axis in graphic representations in these FIG. 2A and FIG. 2B represents a frequency, and the horizontal axis in the graphic representations represents time. Shading gradation in the graphic representations in FIG. 2A and FIG. 2B represents power, where the power higher as the shading is lighter.

As represented by the graphic representation in FIG. 2A and the graphic representation in FIG. 2B, outlines of the spectrum of the stationary noise and the spectrum of the periodic noise are similar to each other, but details thereof are different from each other. For example, the graphic representation in FIG. 2B illustrates an expanded view of an extraction of a part in the vicinity of 1 kHz in the spectrum of the periodic noise. As illustrated in the expanded view, the shading gradation changes in the stated order of light, dark, light, dark, and light in time series. This means that the power changes in the stated order of high, low, high, low, and high in time series. Although the expanded view is omitted herein, the shading gradation remains light in a part in the vicinity of 1 kHz in the spectrum of the stationary noise, and also the power does not change. In this manner, the spectrum of the periodic noise includes a frequency band where the power periodically changes unlike the spectrum of the stationary noise.

[One Aspect of Problem]

As described in the above-mentioned background art section, the above-mentioned periodic noise is not supposed in the above-mentioned noise removal system, and also suppression as countermeasures therefore is not supposed. For this reason, in the above-mentioned noise removal system, noise is estimated under an assumption that noise power remains the same in a voice segment. Therefore, in a case where an input signal includes the above-mentioned periodic noise, an error occurs between the noise where the power is estimated to remain the same and the periodic noise where the power periodically changes. In a case where the error occurs in the noise estimation as described above, distortion may occur in the voice due to excessive suppression or residue of the noise may occur due to insufficient suppression in some cases.

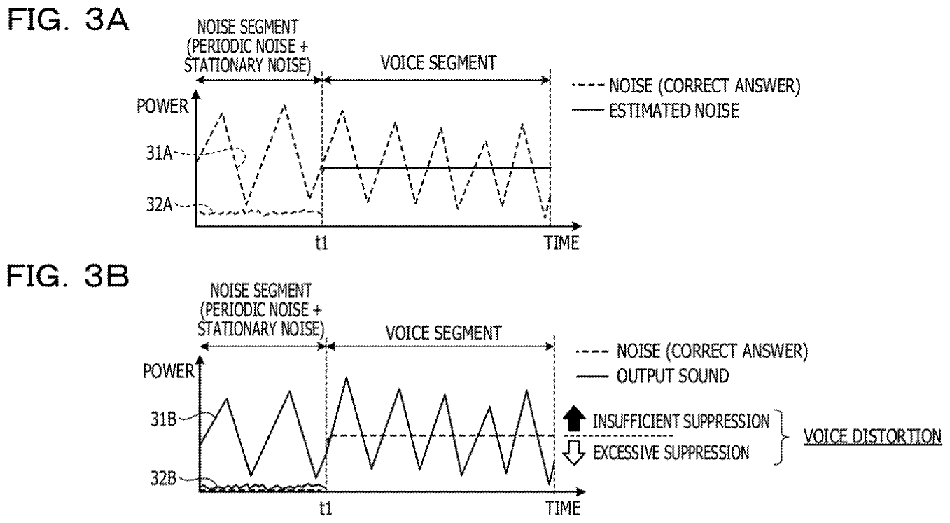

FIG. 3A is a diagram illustrating an example of a temporal waveform of input sound. The vertical axis in a graphic representation in FIG. 3A represents power, and the horizontal axis in the graphic representation represents time. FIG. 3A illustrates input sound in which a detection result of a voice segment switches from a noise segment (non-voice segment) to a voice segment at time ti functioning as a boundary. FIG. 3A further illustrates an extraction of a temporal waveform of a signal component corresponding to a frequency band including periodic noise 31A and stationary noise 32A in the input sound. In FIG. 3A, while a waveform of the estimated noise estimated in the above-mentioned noise removal system is represented by a solid line, a waveform corresponding to components of the periodic noise 31A and the stationary noise 32A in the input sound is represented by a broken line. In the example of FIG. 3A, descriptions will be provided while the power of the voice included in the voice segment of the input sound is set to remain the same.

As represented by the broken line in FIG. 3A, a magnitude of power of the periodic noise 31A periodically changes. On the other hand, as represented by the solid line in FIG. 3A, it is estimated based on the above-mentioned assumption that power of the estimated noise in the above-mentioned noise removal system remains the same. A shift between the power of the periodic noise 31A and the estimated noise appears as an estimation error.

FIG. 3B is a diagram illustrating an example of a temporal waveform of output sound. The vertical axis in a graphic representation in FIG. 3B also represents power, and the horizontal axis in the graphic representation represents time. FIG. 3B also illustrates an extraction of a temporal waveform of a signal component corresponding to a frequency band including periodic noise 31B and stationary noise 32B in the output sound. FIG. 3B further illustrates output sound in which noise suppression is performed from the input sound represented by the broken line in FIG. 3A based on the estimated noise represented by the solid line in FIG. 3A. In FIG. 3B, while a waveform of the output sound is represented by a solid line, a waveform corresponding to a component of the voice (correct answer) in the input sound is represented by a broken line.

As represented by the broken line in FIG. 3B, the voice power in the voice segment remains the same. On the other hand, as represented by the solid line in FIG. 3B, in a case where the noise suppression is performed by the estimated noise in the above-mentioned noise removal system, the estimated noise spectrum is subtracted by spectrum subtraction processing based on a subtraction coefficient. As a result, power levels of the periodic noise 31B and the stationary noise 32B shift downward in the noise segment. In the voice segment, the insufficient suppression and the excessive suppression occur in the output sound. For example, the insufficient suppression of the power of the output sound occurs at a part where the power of the estimated noise is lower than the power of the periodic noise. The excessive suppression of the power of the output sound occurs at a part where the power of the estimated noise is higher than the power of the periodic noise. Distortion of the output sound occurs due to these insufficient suppression and excessive suppression.

In the above-mentioned noise removal system, since the distortion of the output sound occurs due to the estimation error of the periodic noise as described above, the periodic noise superimposed over the input sound is not suppressed in some cases.

[One Aspect of Approach to Solve the Problem]

In view of the above, the noise suppression apparatus 10 according to the present embodiment does not adopt an approach for estimating the noise based on the assumption that the noise power remains the same in the voice segment. That is, for example, the noise suppression apparatus 10 according to the present embodiment estimates the periodic noise in the voice segment based on a cycle of power change in the noise segment before the voice segment is detected from the input sound and suppresses the periodic noise included in the input sound.

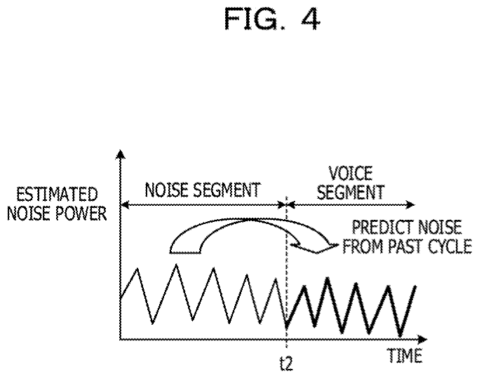

FIG. 4 is a diagram illustrating an example of the temporal waveform of the input sound. The vertical axis in a graphic representation in FIG. 4 represents power, and the horizontal axis in the graphic representation represents time. FIG. 4 illustrates input sound in which the detection result of he voice segment switches from the noise segment (non-voice segment) to the voice segment at time t2 functioning as a boundary. FIG. 4 further illustrates an extraction of a temporal waveform of a signal component corresponding to a frequency band including the periodic noise in the input sound. In FIG. 4, while a waveform corresponding to a component of the periodic noise in the noise segment included in the input sound is represented by a solid line, the periodic noise in the voice segment estimated based on the cycle of the power change in the noise segment is represented by a broken line.

As illustrated in FIG. 4, the voice, segment is not detected from the frame of the input sound until time t2. Thereafter, the voice segment is detected from the frame of the input sound at time t2 and subsequent time. At this time, in the noise suppression apparatus 10 according to the present embodiment, the cycle of the power change in the noise segment before the voice segment is detected from the input sound, that is, for example, in the temporal waveform represented by the solid line in FIG. 4, is used for the estimation of the periodic noise in the voice segment. For this reason, in the noise suppression apparatus 10 according to the present embodiment, the power of the estimated noise is not fixed to remain the same like the above-mentioned noise removal system. In the noise suppression apparatus 10 according to the present embodiment, the periodic noise having a correlation with the cycle of the power change in the immediately preceding noise segment, that is, for example, the temporal waveform represented by the broken line in FIG. 4 is estimated. In this manner, in the noise, suppression apparatus 10 according to the present embodiment, it is possible to estimate the periodic noise that is difficult to be estimated in the above-mentioned noise removal system.

Therefore, it is possible to suppress the periodic noise included in the input sound in accordance with the noise suppression apparatus 10 according to the present embodiment.

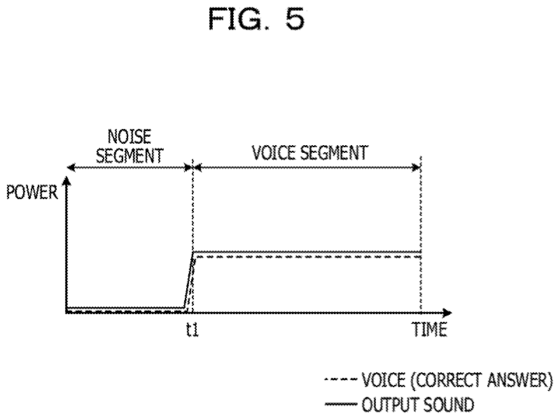

For example, it is possible to suppress the periodic noise included in the input sound illustrated in FIG. 3A in the noise suppression apparatus 10 according to the present embodiment. FIG. 5 is a diagram illustrating an example of the temporal waveform of the output sound. The vertical axis in a graphic representation in FIG. 5 also represents power, and the horizontal axis in the graphic representation represents time. FIG. 5 also illustrates an extraction of a temporal waveform of a signal component corresponding to a frequency band including the periodic noise in the output sound. FIG. 5 further illustrates output sound where noise suppression is performed based on the periodic noise in the voice segment estimated from the cycle of the power change in the noise segment in the temporal waveform of the input sound represented by the broken line in FIG. 3A. In FIG. 5, while a waveform of the output sound is represented by a solid line, a waveform corresponding to a component of the voice (correct answer) in the input sound is represented by a broken line. The waveform of the output sound represented by the solid line in FIG. 5 is substantially matched with the waveform of the voice represented by the broken line in FIG. 5. For this reason, it is understood that the insufficient suppression and the excessive suppression do not occur in the output sound like the example of the noise removal system illustrated in FIG. 3B. In this manner, it is possible to suppress the periodic noise included in the input sound illustrated in FIG. 3A.

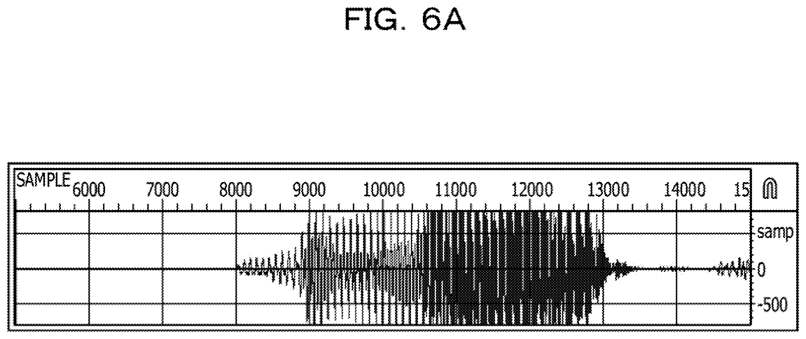

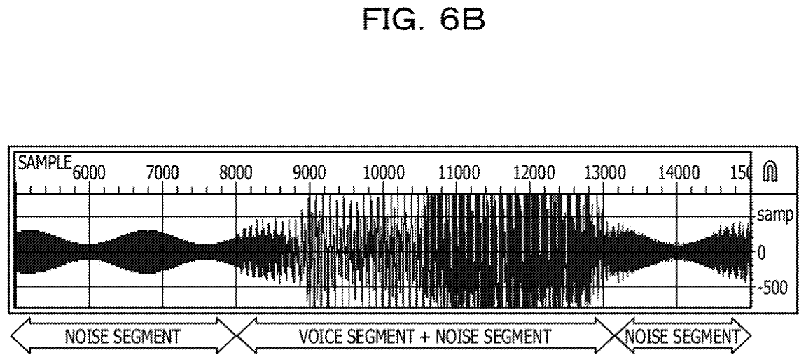

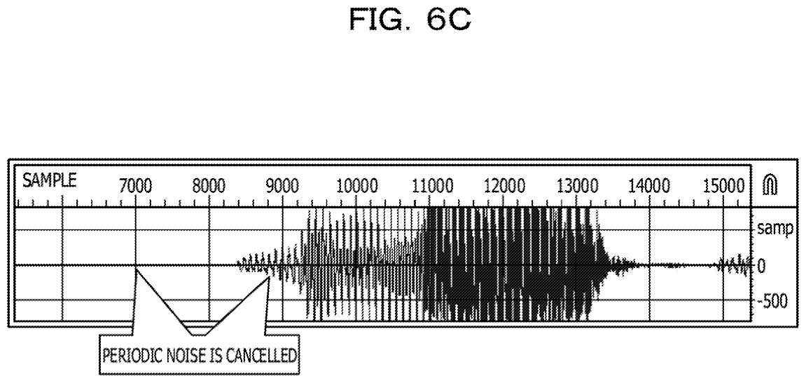

In FIGS. 3A, 3B, 4, and 5, examples in which the temporal waveforms of the input sound and the output sound are schematically illustrated are described, but advantages attained from the above-mentioned noise suppression function are not only theoretical demonstrations but also practical advantages of course. An example of suppression effects of the periodic noise will be described with reference to FIGS. 6A, 6B, and 6C. FIG. 6A is a diagram illustrating an example of a temporal waveform of voice. FIG. 6B is a diagram illustrating an example of a temporal waveform including the periodic noise and the voice. FIG. 6C is a diagram illustrating an example of a temporal waveform of output sound after suppression of the periodic noise. The vertical axis in each of graphic representations in these FIGS. 6A, 6B, and 6C represents an amplitude, and the horizontal axis in each of the graphic representations represents a sampling time. An upper graphic representation in FIG. 6A represents the temporal waveform of the voice. In a case where the periodic noise is superimposed over the temporal waveform of the voice illustrated in FIG. 6A in the band at 1 kHz overlapped with the voice, the temporal waveform illustrated in FIG. 6B is obtained. As illustrated in FIG. 6B, merely as an example, it is clear that the periodic noise where the power periodically changes is superimposed over the voice over entire sampling time. In a case where the noise suppression is performed with respect to the temporal waveform including the voice and the periodic noise illustrated in FIG. 6B based on the periodic noise in the voice segment estimated from the cycle of the power change in the noise segment of the input sound, the temporal waveform of the output sound illustrated in FIG. 6C is obtained. As illustrated in FIG. 6C, as a result of the suppression of the periodic noise over the entire sampling time, it is understood that a waveform equivalent to the temporal waveform of the voice illustrated in FIG. 6A is obtained. In this manner, no difference in the temporal waveform of the voice illustrated in FIG. 6A exists from the output sound in the noise segment and also the voice segment. It may be mentioned from the above that it is practically clear that the periodic noise may be suppressed from the input voice by adopting the above-mentioned noise removal function.

[One Example of Functional Configuration]

As, illustrated in 1, the noise suppression apparatus 10 includes an obtaining unit 11, a transform unit 12A, an inverse transform unit 12B, a voice segment detection unit 13, and a power calculation unit 14. The noise suppression apparatus 10 further includes a stationary noise estimation unit 15, a periodic noise determination unit 16, a periodic noise estimation unit 17, a gain calculation unit 18, and a suppression unit 19. The noise suppression apparatus 10 may also include various functional units included in related-art computers in addition to the functional units illustrated in FIG. 1. For example, the noise suppression apparatus 10 may also include a function unit and the like configured to execute application programs represented by voice recognition and also voice assistant, voice translation, and the like.

The functional units corresponding to the respective blocks illustrated in FIG. 1 are virtually realized by a hardware processor such as a central processing unit (CPU) or a microprocessor unit (MPU). For example, the processor reads out a noise suppression program for realizing the above-mentioned noise suppression function from a storage device that is not illustrated, such as a hard disk drive (HDD), an optical disk, or a solid state drive (SSD) in addition to an operating system (OS). The processor executes the noise suppression program to load a process corresponding to the above-mentioned functional units onto a memory such as a random-access memory (RAM). As a result, the above-mentioned functional units are virtually realized as the process.

The example in which the above-mentioned noise suppression program is executed has been described merely as one aspect, but the configuration is not limited to this. For example, the above-mentioned noise suppression program may be executed as package software in which functions corresponding to services such as voice recognition, voice recognition AI assistant, and voice translation are packaged.

Although the CPU and the MPU are exemplified as one example of the processor, the functional units described above may be implemented by any processor regardless of whether the processor is a general-purpose type or a specific type. In addition, the functional units described above may be implemented by a hard wired logic circuit such as an application specific integrated circuit (ASIC) or a field-programmable gate array (FPGA).

The obtaining unit 11 is a processing unit configured to obtain input sound.

The obtaining unit 11 obtains a signal transformed from an acoustic wave by a microphone that is not illustrated as the input sound merely as one example source that obtains the input sound by the obtaining unit 11 may be arbitrary and is not limited to the microphone. For example, the obtaining unit 11 may also obtain the input sound by reading out the input sound from an auxiliary storage device such as a hard disc or an optical disc that accumulates sound data or a removable medium such as a memory card or a Universal Serial Bus (USB) memory. In addition, the obtaining unit 11 may also obtain stream data of voice by receiving from an external apparatus via a network as the input sound,

The transform unit 12A is a processing unit configured to transform a frame of the input sound from a time domain into a frequency domain.

As one embodiment, each time the obtaining unit 11 obtains the frame of the input sound, the transform unit 12A applies Fourier transform represented by fast Fourier transform (FFT) to the frame of the input sound to obtain FFT coefficients having an increment of a predetermined frequency. When a sampling frequency of the input sound is 16 kHz, merely as one example, a frame length used for FFT analysis may be set as approximately 512 samples.

The voice segment detection unit 13 is a processing unit configured to detect the voice segment,

As one aspect, the voice segment detection unit 13 may detect the voice segment by manually accepting a specification of a period via a user interface that is not illustrated. This user interface may be realized by hardware such as a physical switch or realized by software via display of a touch panel or the like. For example, the frame of the input sound input from the obtaining unit 11 during a period in which a press operation of a button continues may be identified as the voice segment. In addition, the frame of the input sound input from the obtaining unit 11 during a period in which the press operation is performed at start and end timings of the voice segment may be identified as the voice segment.

As another aspect, the voice segment detection unit 13 may also estimate the voice segment from the input sound. For example, the voice segment detection unit 13 may detect start and end of the voice segment based on an amplitude and zero-crossing of the waveform of the input sound, or may calculate a voice likelihood and a non-voice likelihood in accordance with a Gaussian mixture model (GMM) for each frame of the input sound and detect the voice segment from a ratio of these likelihoods. The voice segment may also be detected by using the technology of Japanese Laid-open Patent Publication No. 8-221092 or the like.

In accordance with the detection of these voice segments, for each frame of the input sound, the frame is labeled as the voice segment or the non-voice segment. Hereinafter, the non-voice segment that is identified that this segment is not the voice segment in the temporal waveforms of the input sound may be referred to as “noise segment” in some cases.

The power calculation unit 14 is a processing unit configured to calculate power of the frame of the input sound.

As one embodiment, the power calculation unit 14 calculates power of the frame based on a frequency analysis result of the frame where the transform unit 12A executes the FFT for each frequency band. For example, when a current frame is set as “f” and a frequency band is set as “b”, the power calculation unit 14 may calculate power I²[f, b] in the current frame f by calculating a squared-sum of a real number part and an imaginary number part of the FFT coefficient included in the frequency band b. A band width of the frequency band may be set as approximately 100 Hz merely as an example.

The stationary noise estimation unit 15 is a processing unit configured to estimate stationary noise of the input sound.

As one embodiment, the stationary noise estimation unit 15 may estimate the stationary noise in the frame of the input sound from the power in the noise segment for each frequency band. For example, the stationary noise estimation unit 15 may calculate power Nt²[f, b] of the stationary noise in the frequency band b in the current frame fin accordance with the following expression (1) and the following expression (2). At this time, in a case where the current frame is the “noise segment”, the stationary noise estimation unit 15 calculates the power Nt²[f, b] of the stationary noise in accordance with the following expression (1). On the other hand, in a case where the current frame is the “voice segment”, the stationary noise estimation unit 15 calculates the power Nt²[f, b] of the stationary noise in accordance with the following expression (2).

Nt²[f, b]=a×Nt²[f−1, b]+(1−a)I²[f, b] (1)

Nt²[f, b]=Nt²[f−1, b] (2)

“Nt²[f−1, b]” in the above-mentioned expression (1) denotes the stationary noise in a frame f−1 corresponding to a frame one frame before the current frame f. “a” in the above-mentioned expression (1) denotes a coefficient used for absorbing a sudden change of the stationary noise.

The periodic noise determination unit 16 is a processing unit configured to determine whether or not the periodic noise is included in the frame of the input sound. In a case where the frame of the input sound is the voice segment, there is a possibility that both the voice and the periodic noise are superimposed over the input sound. For this reason, it may be difficult to determine the presence or absence of the periodic noise in the frame belonging to the voice segment as compared with the frame belonging to the noise segment in some cases. From the above-mentioned aspect, the determination result regarding the presence or absence of the periodic noise which has been determined in the noise segment immediately before the voice segment is inherited in the frame belonging to the voice segment.

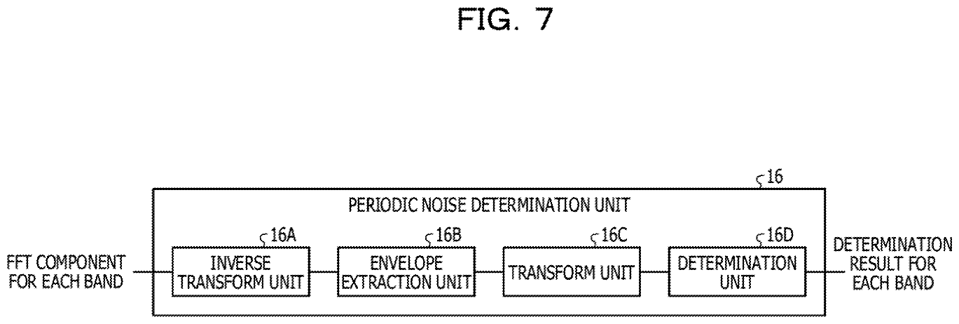

FIG. 7 is a diagram illustrating an example of a functional configuration of the periodic noise determination unit 16. As illustrated in 7, the periodic noise determination unit 16 includes an inverse transform unit 16A, an envelope extraction unit 16B, a transform unit 16C, and a determination unit 16D.

The inverse transform unit 16A is a processing unit configured to perform an inverse transform of a frequency analysis result of the frame of the input sound for each frequency band from the frequency domain into the time domain.

As one embodiment, the inverse transform unit 16A applies inverse fast Fourier transform (FFT) to an FFT coefficient in the frequency band b and obtains a signal of a component corresponding to the frequency band b among signals in the frame f of the input sound. The temporal waveform of the signal obtained for each frequency band b as described above is saved in a work area that is not illustrated not only in the current frame f but also as far back as a predetermined period. For example, from an aspect in which the periodic noise having a cycle of approximately 1 Hz falls within a range of detectability, the signal having a time length of one second back from the current frame f is accumulated for each frequency band b.

The envelope extraction unit 166 is a processing unit configured extract an envelope.

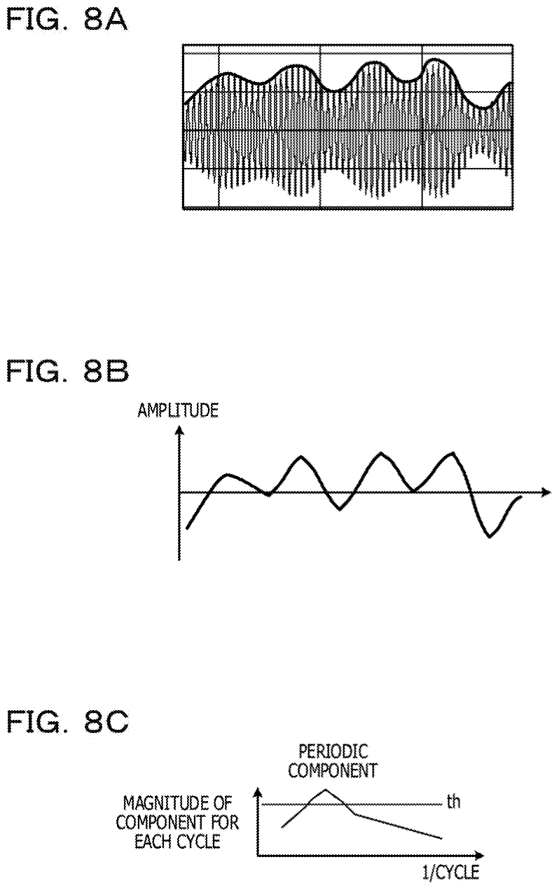

As one embodiment, the envelope extraction unit 16B executes the following processing for each frequency band b. FIG. 8A is a diagram illustrating an example of a temporal waveform in a specific frequency band. FIG. 8A illustrates a temporal waveform of a signal in the past one second in a certain frequency band b. For example, as illustrated in 8A, the envelope extraction unit 166 extracts an envelope of a curved line group included in the temporal waveform of the signal in the past one second in the frequency band b, that is, for example, a bold line part in FIG. 8A. The envelope may be extracted by using a related-art arbitrary technique, such as, for example, Hilbert transform or envelope detection.

The transform unit 16C is a processing unit configured to transform the envelope from the time domain into the frequency domain for each frequency band.

As one embodiment, the transform unit 16C executes the following processing for each frequency band b. For example, the transform unit 16C applies a high-pass filter or the like to temporal waveform of the envelope in the frequency band b which has been extracted by the envelope extraction unit 16B. FIG. 8B illustrates an example of the temporal waveform of the envelope. For example, when the temporal waveform of the envelope represented by the bold line in FIG. 8A is input to the high-pass filter or the like, as illustrated in FIG. 8B, the temporal waveform of the envelope in which direct current (DC) components are cut is obtained. Thereafter, the transform unit 16C applies FFT to the temporal waveform of the envelope in which the DC components are cut. With this configuration, the FFT coefficients having the increment of the predetermined frequency are obtained as the frequency analysis result of the temporal waveform of the envelope.

The determination unit 16D is a processing unit configured to determine whether or not a frequency component exceeding a predetermined threshold exists. The determination unit 16D corresponds to an example of a detection unit.

As one embodiment, the determination unit 16D executes the following processing for each frequency band b. For example, the determination unit 16D determines whether or not power measured at a peak in the frequency analysis result of the temporal waveform of the envelope in the frequency band b obtained by the transform unit 16C exceeds the predetermined threshold. FIG. 8C is a diagram illustrating an example of a power spectrum. FIG. 8C illustrates a transform of the output result of the FFT of the temporal waveform of the envelope illustrated in FIG. 8B into a power spectrum. A vertical axis in a graphic representation in FIG. 8C represents power, and a horizontal axis in the graphic representation represents a frequency (1/cycle). For example, it is determined whether or not the power measured at the peak in the power spectrum illustrated in FIG. 8C exceeds a predetermined threshold th. As one aspect, the above-mentioned threshold th may be set in accordance with an analysis length used in the FFT by the transform unit 12A, a time length of the signal set as an extraction target of the envelope, a band width of the frequency band, and the like. In a case where the power at the peak in the power spectrum exceeds the threshold th, the determination unit 16D determines that the periodic noise is included in the frequency band b in the frame of the input sound. In this case, the determination unit 16D outputs the determination result indicating the presence of the periodic noise in the frequency band b and also the frequency at which the power exceeds the threshold th in the power spectrum or a cycle obtained from the frequency to the periodic noise estimation unit 17 as a periodic component. On the other hand, in a case where the power at the peak in the power spectrum does not exceed the threshold th, the determination unit 16D determines that the periodic noise is not included in the frame of the input sound.

With reference to FIG. 1 again, the periodic noise estimation unit 17 is a processing unit configured to estimate the periodic noise. For example, the periodic noise estimation unit 17 estimates the periodic noise in a case where the periodic noise determination unit 16 determines that the periodic noise exists in the frequency band b in the frame f. The periodic noise estimation unit 17 corresponds to an example of a calculation unit.

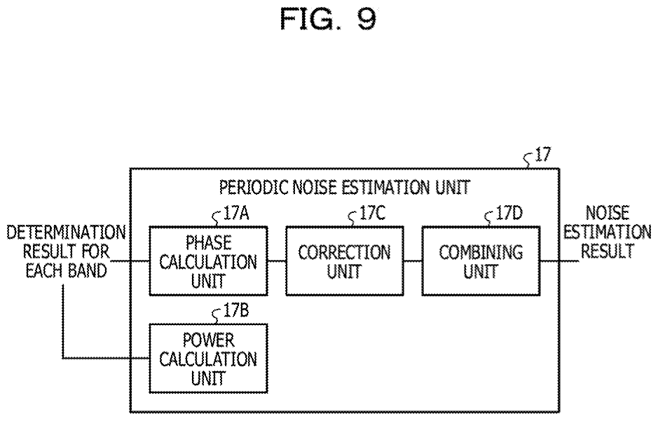

FIG. 9 is a diagram illustrating an example of a functional configuration of the periodic noise estimation unit 17. As illustrated in 9, the periodic noise estimation unit 17 includes a phase calculation unit 17A, a power calculation unit 17B, a correction unit 17C, and a combining unit 17D.

The phase calculation unit 17A is a processing unit configured to calculate a phase of the periodic noise.

As one embodiment, the phase calculation unit 17A operates in a case where the frame of the input sound is the noise segment. For example, the phase calculation unit 17A assigns the FFT coefficient corresponding to the frequency at which it is determined that the power exceeds the threshold th in the power spectrum of the envelope among the frequencies included in the frequency band b in the frame f where the determination unit 16D determines that the periodic noise exists to the following expression (3). Accordingly, phase[f, b] is calculated. This phase[f, b] is calculated in a range between 0 and 2π[rad] by the following expression (3). The thus calculated phase[f, b] in the frequency band b is saved in the work area not illustrated from the latest frame to a predetermined N frames among the frames belonging to the noise segment.

phase[f, b]=arctan(real[f, b]/imag[f, b]) (3)

The power calculation unit 17B is a processing unit configured to calculate the power of the periodic noise.

As one embodiment, the power calculation unit 17B operates in a case where the frame of the input sound is the noise segment. For example, the power calculation unit 176 assigns the FFT coefficient corresponding to the frequency at which it is determined that the power exceeds the threshold th in the power spectrum of the envelope among the frequencies included in the frequency band b in the frame f where the determination unit 16D determines that the periodic noise exists to the following, expression (4). Accordingly, power[f, b] is calculated. The thus calculated power[f, b] in the frequency band b is saved in the work area not illustrated from the latest frame to the predetermined N frames among the frames belonging to the noise segment.

power[f, b]=(real[f, b]×real[f, b])+(imag[f, b]×imag[f, b]) (4)

The correction unit 17C is a processing unit configured to correct the phase of the periodic noise.

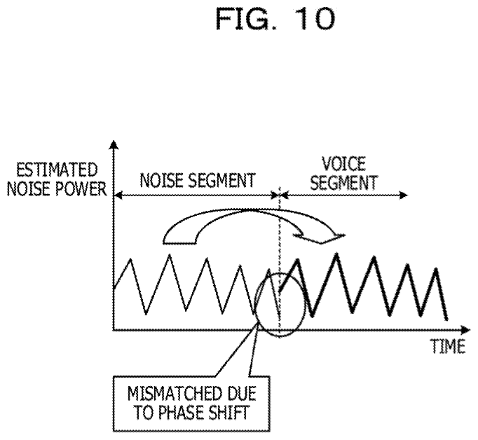

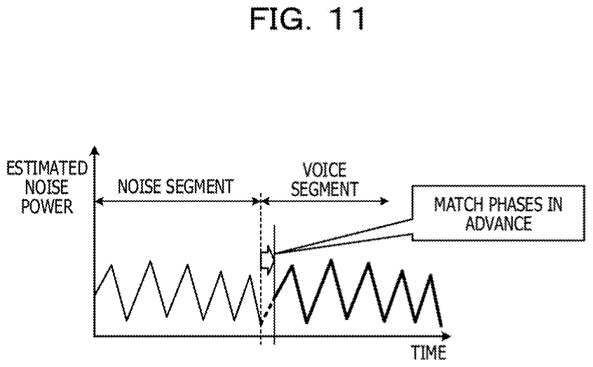

As one embodiment, the correction unit 17C operates in a case where the frame of the input sound is the voice segment. For example, the correction unit 17C corrects a phase in the noise segment immediately before the voice segment into a phase of the periodic noise in the current frame f by a linear prediction. FIGS. 10 and 11 are diagrams illustrating an example of a phase correction method. The vertical axis in a graphic representations in FIGS. 10 and 11 represents power, and the horizontal axis in the graphic representations represents time. FIG. 10 illustrates an example of a case where the waveform of the periodic noise is replicated in the voice segment while the phase in the immediately preceding noise segment is kept. On the other hand, FIG. 11 illustrates an example of a case where the waveform of the periodic noise is replicated in the voice segment after the phase in the immediately preceding noise segment is corrected into a phase at a start time point of the voice segment by the above-mentioned linear prediction. As illustrated in FIG. 10, in a case where the periodic noise is replicated while the phase in the immediately preceding noise segment is kept, since the cycle of the waveform is not matched with a start point and an end point of the frame, a phase shift occurs. That is, for example, the phase at an end time point of the frame in the noise segment immediately before the voice segment is not necessarily matched with the phase at the start time point of the frame in the immediately preceding noise segment used for the replication. For this reason, the periodic noise having continuity between the noise segment and the voice segment is not predicted in some cases. On the other hand, as illustrated in FIG. 11, in a case where the periodic noise is replicated after the correction into the phase at the start time point of the voice segment is performed by the above-mentioned linear prediction, the shift based on the time difference between the noise segment and the voice segment may be cancelled by the correction.

More specifically, for example, the phases are saved in the work area not illustrated from the latest frame to the predetermined N frames among the frames belonging to the noise segment. For example, when frames between one to N frames before the voice segment are set as the noise segment, phase[f−1, b] to phase[f−N+1, b] are saved in the work area. When the above-mentioned phases in the immediately preceding noise segment are assigned to the following expression (5) the correction unit 17C calculates the phase of the periodic noise in the frequency band b in the current frame f. In the following expression (5), the phases of the two frames in the immediately preceding noise segment are used, but the correction may also be performed by using phases of N frames. For example, it is possible to change an interval of frames where a difference is calculated at a second term in accordance with the number of passing frames from the frame in the immediately preceding noise segment to the current frame fin the voice segment.

phase[f, b]=phase[f−1, b]+(phase[f−1, b]−phase[f−2, b] (5)

The combining unit 17D is a processing unit configured to combine the phase and the power of the periodic noise with each other.

As one embodiment, the combining unit 17D calculates a real number component preal[f, b] of the estimated periodic noise in accordance with the following expression (6) and also calculates an imaginary number component pimag[f, b] of the estimated periodic noise in accordance with the following expression (7). At this time, in a case where the current frame f is the noise segment, the phase[f, b] calculated by the phase calculation unit 17A in the current frame f and the power[f, b] calculated by the power calculation unit 17B in the current frame f are used. On the other hand, in a case where the current frame f is the voice segment, the phase corrected by the correction unit 17C from the phase of the immediately preceding noise segment is used as the phase[f, b] in the current frame f, and also the power of the frame in the immediately preceding noise segment which is saved in the work area is used as the power[f, b] in the current frame. The combining unit 17D calculates power Ns² of the estimated periodic noise in accordance with the following expression (8) from the real number component preal[f, b] of the estimated periodic noise and the imaginary number component pimag[f, b] of the estimated periodic noise.

preal[f, b]=√power[f, b]×cos(phase[f, b]) (6)

pimag[f, b]=√power[f, b]×sin(phase[f, b]) (7)

Ns²=IFF(preal[f, b], pimag[f, b]) (8)

The gain calculation unit 18 is a processing unit configured to calculate a gain of the frame of the input sound.

Various methods are used for calculating the gain and suppressing noise, but a case is exemplified hereinafter where a method called spectrum subtraction method is used merely as an example. For example, when power of the input sound is set as I²[f, b], power of voice included in the input sound is set as S²[f, b], and noise included in the input sound is set as N²[f, b], it is assumed that the following expression (9) is established. It is further assumed that the input sound is multiplied by gain[f, b] represented in the following expression (10). Under these assumptions, gain[f, b] may be obtained from the following expression (11). In a case where the periodic noise is included in the frequency band b, the periodic noise Ns[f, b] is applied to N[f, b], and in a case where the periodic noise is not included in the frequency band b, the stationary noise Nt[f, b] is applied to N[f, b]. An example has been described in which only the periodic noise Ns[f, b] is used in a case where the periodic noise is included in the frequency band b merely as an example, but weighting addition may also be performed between the stationary noise Nt[f, b] and the periodic noise Ns[f, b] in accordance with the magnitude of the cycle of the periodic noise, “sqrt{}” in the following expression (11) denotes a square root.

I²[f, b]=S²[f, b]+N²[f, b] (9)

S[f, b]=gain[f, b]×I[f, b] (10)

gain[f, b]=sqrt{(1−N²[f, b])/(I²[f, b])} (11)

The suppression unit 19 is a processing unit configured to suppress noise. The suppression unit 19 corresponds to one example of the correction unit.

As one embodiment, the suppression unit 19 multiplies the FFT coefficient in the frequency band b in the frame f of the input sound by the gain gain[f, b] calculated by the gain calculation unit 18 in accordance with the following expression (12) to calculate output sound O[f, b].

O[f, b]=gain[f, b]×I[f, b] (12)

The inverse transform unit 12B is a processing unit configured to perform an inverse transform of the frequency analysis result for each frequency band after the gain multiplication from the frequency domain into the time domain.

As one embodiment, the inverse transform unit 12B applies IFFT to the FFT coefficient of the output sound in each frequency band b where the input sound I[f, b] is multiplied by the gain gain[f, b] for each frequency band b by the suppression unit 19. As a result, the temporal waveform of the output sound is obtained in which the voice is emphasized due to the noise suppression.

[Processing Sequence]

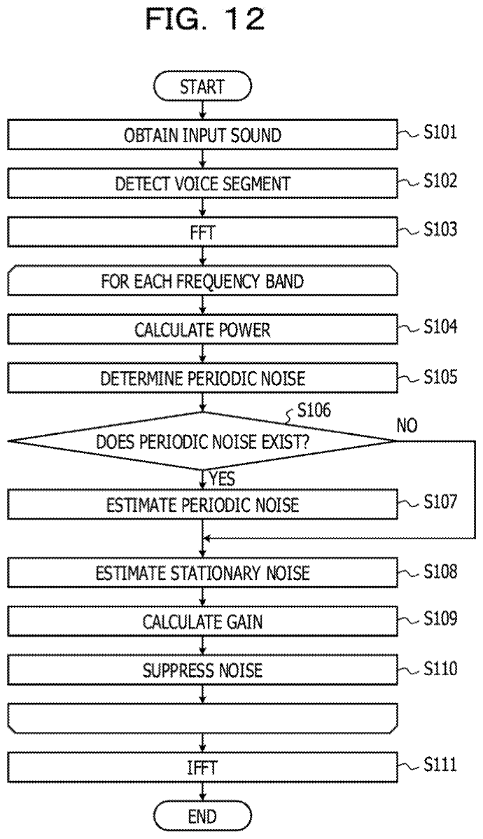

FIG. 12 is a flowchart illustrating a procedure of noise suppression processing according to the first embodiment. This processing is executed as an example in a case where the obtaining unit 11 obtains the frame of the input sound. As illustrated in FIG. 12, the obtaining unit 11 obtains the frame of the input sound (step S101). When the frame of the input sound is obtained as described above, the voice segment detection unit 13 detects whether the frame of the input sound obtained in step S101 is the voice segment or the noise segment (step S102).

The transform unit 12A applies Fourier transform represented by FFT to the frame of the input sound obtained in step S101 (step S103). The FFT coefficients having the increment of the predetermined frequency are obtained by this processing in step S103.

Thereafter, the processing from step S104 to step S110 illustrated in FIG. 12 is executed in units of the frequency band b. Processing contents are not varied in a case where the processing from step S104 to step S110 illustrated in FIG. 12 is executed for each frequency band b in parallel and also in a case where the processing is executed in a predetermined order of the frequency bands b.

For example, in step S104, a squared-sum of a real number part and an imaginary number part of the FFT coefficient included in the frequency band b set as the processing target among the frames of the input sound obtained in step S101 is calculated to calculate the power I²[f, b] in the current frame f (step S104).

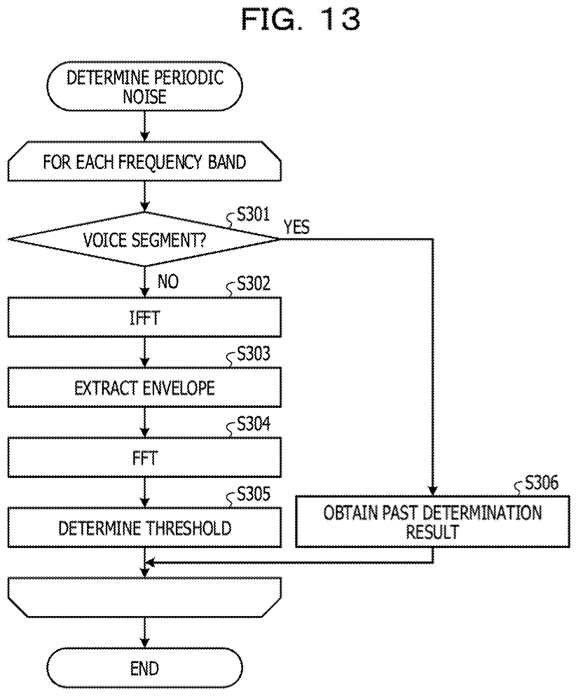

The periodic noise determination unit 16 subsequently executes the “periodic noise determination processing” for determining whether or not the periodic noise is included in the frame of the input sound (step S105). A detail of processing contents of this “periodic noise determination processing” will be illustrated in FIG. 13.

FIG. 13 is a flowchart illustrating a procedure of the periodic noise determination processing according to the first embodiment. This processing is executed after the processing in step S104 illustrated in FIG. 12. As illustrated in FIG. 13, the processing from step S301 to step S306 described below is executed for each frequency band b.

In a case where the frame of the input sound is the “noise segment” (step S301 No), the inverse transform unit 16A applies IFFT to the FFT coefficient in the frequency band b (step S302). A signal of the component corresponding to the frequency band b among the signals in the frame f of the input sound is obtained by this processing in step S302,

The envelope extraction unit 16B subsequently extracts an envelope of a curved line group included in the temporal waveform of the signal in a past predetermined period, for example, one second, in the frequency band b (step S303). The transform unit 16C applies FFT to the temporal waveform of the envelope extracted in step S303 (step S304). With this configuration, the FFT coefficients having the increment of the predetermined frequency are obtained as the frequency analysis result of the temporal waveform of the envelope.

Thereafter, the determination unit 16D determines whether or not the power measured at the peak in the power spectrum obtained from the FFT coefficients of the envelope in the frequency band b obtained in step S304 exceeds a predetermined threshold, for example, the threshold th illustrated in FIG. 8C. With this configuration, it is determined whether or not the periodic noise is included in the frequency band b obtained in step S304, and the processing is ended (step S305).

On the other hand, in a case where the frame of the input sound is the “voice segment” (step S301 Yes), the determination unit 16D refers to the determination result regarding the presence or absence of the periodic noise which is determined in the noise segment immediately before the voice segment (step S306), and the processing is ended.

With reference to the flowchart in FIG. 12 again, in a case where the periodic noise is included in the frequency band b (step S106 Yes), the periodic noise estimation unit 17 executes the “periodic noise estimation processing” for estimating the periodic noise (step S107). In a case where the periodic noise is not included in the frequency band b (step S106 No), the processing in step S107 is skipped, and the flow shifts to step S108.

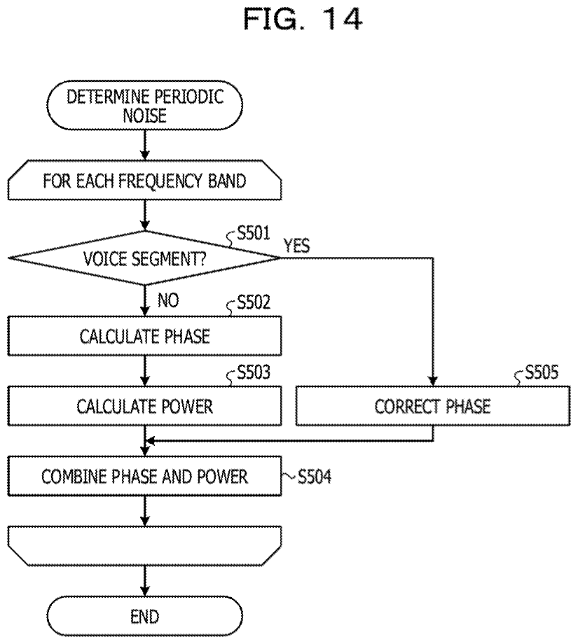

A detail of processing contents of this “periodic noise estimation processing” will be illustrated in FIG. 14. FIG. 14 is a flowchart illustrating a procedure of the periodic noise estimation processing according to the first embodiment. This processing is executed in a case where the flow takes Yes branch in step S106 illustrated in FIG. 12. As illustrated in FIG. 14, the processing from step S501 to step S505 described below is executed for each frequency band b.

In a case where the frame of the input sound is the “noise segment” (step S501 No), the phase calculation unit 17A assigns the FFT coefficient corresponding to the frequency at which it is determined that the power exceeds the threshold in the power spectrum of the envelope among the frequencies included in the frequency band b in the frame f where it is determined that the periodic noise exists to the above-mentioned expression (3) to calculate the phase [f, b] (step S502).

The power calculation unit 17B subsequently assigns the FFT coefficient corresponding to the frequency at which it is determined that the power exceeds the threshold in the power spectrum of the envelope among the frequencies included in the frequency band b in the frame f where it is determined that the periodic noise exists to the above-mentioned expression (4) to calculate the power [f, b] (step S503).

The combining unit 17D calculates the power Ns² of the estimated periodic noise based on the phase and the cycle calculated in step S502 and step S503 (step S504), and the processing is ended.

On the other hand, in a case where the frame of the input sound is the “voice segment” (step S501 Yes), the correction unit 17C corrects the phase of the noise segment immediately before the voice segment into the phase of the periodic noise in the current frame f by the linear prediction (step S505).

The combining unit 17D calculates the power Ns² of the estimated periodic noise based on the phase corrected from the phase in the immediately preceding noise segment in step S505 and the power of the frame in the immediately preceding noise segment which has been saved in the work area (step S504), and the processing is ended,

With reference to the flowchart in FIG. 12 again, the stationary noise estimation unit 15 switches to use the above-mentioned expression (1) or the above-mentioned expression (2) depending on whether the current frame f corresponds to the voice segment or the noise segment and calculates the power Nt²[f, b] of the stationary noise in the frequency band b in the current frame f (step S108).

The gain calculation unit 18 subsequently switches to use the periodic noise Ns[f, b] or the stationary noise Nt[f, b] as N[f, b] depending on whether or not the periodic noise is included in the frequency band b and calculate the gain gain[f, b] by which the input sound is multiplied in accordance with the above-mentioned expression (11) (step S109).

Thereafter, the suppression unit 19 multiplies the FFT coefficient in the frequency band b in the frame f of the input sound by the gain gain[f, b] calculated in step S109 in accordance with the following expression (12) to calculate output sound O[f, b] (step S110).

After the processing from these step S104 to step S110 is executed with respect to all the frequency bands b, the inverse transform unit 12B applies IFFT to the FFT coefficient of the output sound in each frequency band b where the input sound I[f, b] is multiplicated by the gain gain[f, b] for each frequency band b (step S111), and the processing is ended.

In accordance with this processing in step S111, the temporal waveform of the output sound is obtained in which the voice is emphasized due to the noise suppression.

[One Aspect of Effects]

As described above, the noise suppression apparatus 10 according to the present embodiment estimates the periodic noise in the voice segment based on the cycle of the power change in the noise segment before the voice segment is detected from the input sound and suppresses the periodic noise included in the input sound.

At this time, in the noise suppression apparatus 10 according to the present embodiment, the cycle of the power change in the noise segment before the voice segment is detected from the input sound is used for the estimation of the periodic noise in the voice segment. For this reason, in the noise suppression apparatus 10 according to the present embodiment, the power of the estimated noise is not fixed to remain the same like the above-mentioned noise removal system. In the noise suppression apparatus 10 according to the present embodiment, the periodic noise having the correlation with the cycle of the power change in the immediately preceding noise segment is estimated. In this manner, in the noise suppression apparatus 10 according to the present embodiment, it is possible to estimate the periodic noise that is difficult to be estimated in the above-mentioned noise removal system.

Therefore, in accordance with the noise suppression apparatus 10, it is possible to suppress the periodic noise included in the input sound.

### Second Embodiment

Heretofore, the embodiment of the devices of the present disclosure have been described, but it is to be understood that embodiments of the present disclosure may be made in various ways other than the above-mentioned embodiments. Therefore, other embodiments included in the present disclosure are described below.

### IMPLEMENTATION EXAMPLE

The above-mentioned noise suppression function described in the first embodiment may be incorporated in various devices such as a mobile terminal apparatus represented by a smart phone, a wearable terminal, a smart speaker, and a communication robot. In this case, input sound input to a microphone included in the device is obtained to execute the processing illustrated in FIGS. 12, 13, and 14, and a temporal waveform of output sound after noise suppression may be output to an application executed in backend in addition to an application operating over the device. The above-mentioned noise suppression function described in the first embodiment may be provided as a noise suppression service. For example, a server apparatus to which the above-mentioned noise suppression function is mounted may obtain input sound from an arbitrary client terminal and execute the processing illustrated in FIGS. 12, 13, and 14 to output the temporal waveform of the output sound after the noise suppression to the client terminal. In this case too, the noise suppression function may be provided not only as the noise suppression service but also as a package as voice translation and voice assistant.

### MODIFIED EXAMPLE

According to the above-mentioned first embodiment, the example has been described in which the correction based on the linear correction by the correction unit 17C is executed at the time of the transition from the noise segment to the voice segment, but the correction based on the linear correction by the correction unit 17C may also be executed in the case of the transition from the voice segment to the noise segment.

According to the above-mentioned first embodiment, the example in which the periodic noise is generated in a stationary manner, for example, the example in which the periodic noise is generated in the entire sampling time has been described from the viewpoint of the example of FIG. 6B but it is also sufficient even when the periodic noise is necessarily generated in a stationary manner. For example, in a case where the periodic noise discontinues in the midcourse of the voice segment such as, for example, a case where the periodic noise is not detected at and after sample 13000 of the temporal waveform illustrated in FIG. 6B, step S107 in FIG. 12 may be omitted. In a case where the periodic noise is, generated in the midcourse of the voice segment such as, for example, a case where the periodic noise is detected at and after sample 13000 of the temporal waveform illustrated in FIG. 6B in the noise segment, the periodic noise may also be suppressed as follows. That is, for example, the periodic noise generated in the midcourse of the voice segment may be suppressed based on the power and the phase of the periodic noise calculated in the frame at or after sample 13000. In this case, since phase shift occurs at a start point of the frame used for the calculation for the power and the phase and a start point of the frame where the periodic noise suppression is started in the voice segment, the phase shift may be corrected by the linear prediction by the correction unit 17C.

According to the above-mentioned first embodiment, from an aspect in which the signal of the input sound is processed in real time, the example has been illustrated in which the noise in the voice segment is suppressed based on the periodic noise estimated from the cycle of the power change in the noise segment immediately before the voice segment, but the configuration is not limited to this. For example, it is also sufficient when the signal of the input sound is not necessarily processed in real time. In this case, it is possible to suppress the periodic noise generated after the frame where the periodic noise has been detected by the processing in step S106 and suppress the periodic noise generated before the frame. For example, in a case where the periodic noise is generated in the midcourse of the voice segment such as, for example, a case where the periodic noise is detected at and after sample 8000 of the temporal waveform illustrated in FIG. 6B, the periodic noise may be suppressed as follows That is, for example, it is possible to suppress the periodic noise in an arbitrary frame based on the periodic noise estimated from the cycle of the power change at and after sample 8000, for example, at and after sample 14000 corresponding to the noise segment, for example, irrespective of distinctions among frames at and before sample 14000, for example, the voice segment between sample 8000 and sample 13500 and other noise segments,

[Distribution and Integration]

The respective components of the respective devices illustrated in the drawings do not necessarily have to be physically configured as illustrated in the drawings. Specific forms of the distribution and integration of the devices are not limited to the illustrated forms, and all or a portion thereof may be distributed and integrated in any units in either a functional or physical manner depending on various conditions such as a load and a usage state. For example, the obtaining unit 11, the transform unit 12A, the inverse transform unit 12B, the voice segment detection unit 13, the power calculation unit 14, the stationary noise estimation unit 15, the periodic noise determination unit 16, the periodic noise estimation unit 17, the gain calculation unit 18, or the suppression unit 19 may be coupled via a network as external devices of the noise suppression apparatus 10. Different devices may respectively include the obtaining unit 11, the transform unit 12A, the inverse transform unit 12B, the voice segment detection unit 13, the power calculation unit 14, the stationary noise estimation unit 15, the periodic noise determination unit 16, the periodic noise estimation unit 17, the gain calculation unit 18, or the suppression unit 19 and are coupled via the network to co-operate, and the above-mentioned functions of the noise suppression apparatus 10 may also be realized.

[Noise Suppression Program]

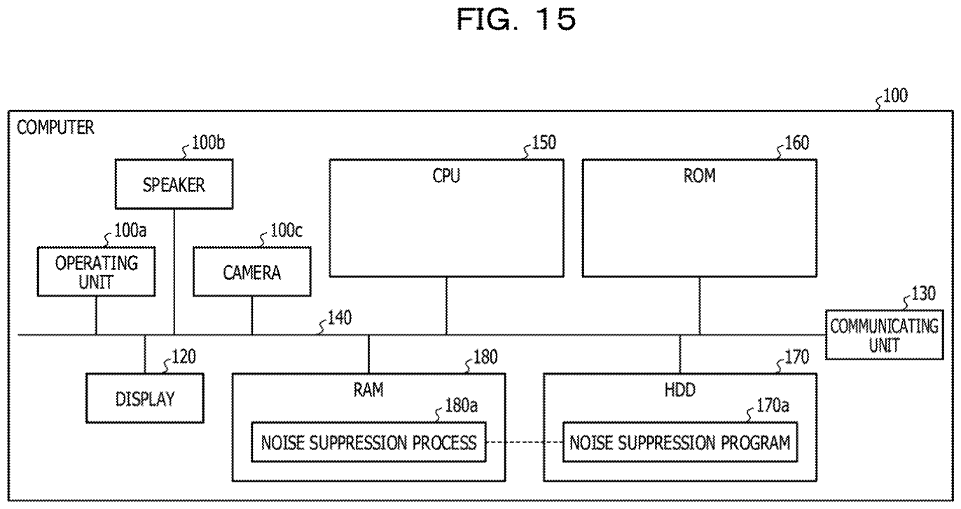

The various types of processing described in the above-mentioned embodiments may be implemented by executing a program prepared in advance in a computer such as a personal computer or a work station. Hereinafter, with reference to FIG. 15, an example of a computer configured to execute a noise suppression program having functions similar to the above-mentioned embodiments will be described.

FIG. 15 is a diagram illustrating a hardware configuration example of a computer configured to execute the noise suppression program according to the first and second embodiments. As illustrated in FIG. 15, the computer 100 includes an operation unit 110a, a speaker 1101), a microphone 110c, a display 120, and a communication unit 130. The computer 100 further includes a CPU 150, a read-only memory (ROM) 160, an HDD 170, and a RAM 180. These units 110 to 180 are coupled to each other via a bus 140,

As illustrated in FIG. 15, the HDD 170 stores a noise suppression program 170a for realizing the functions similar to the obtaining unit 11, the transform unit 12A, the inverse transform unit 12B, the voice segment detection unit 13, the power calculation unit 14, the stationary noise estimation unit 15, the periodic noise determination unit 16, the periodic noise estimation unit 17, the gain calculation unit 18, and the suppression unit 19 illustrated in the above mentioned first embodiment. The noise suppression program 170a may be integrated or separated similarly as in the respective components including the obtaining unit 11, the transform unit 12A, the inverse transform unit 12B, the voice segment detection unit 13, the power calculation unit 14, the stationary noise estimation unit 15, the periodic noise determination unit 16, the periodic noise estimation unit 17, the gain calculation unit 18, and the suppression unit 19 illustrated in FIG. 1. That is, for example, the HDD 170 may not necessarily store all of the data described in the first embodiment, but the HDD 170 may store only data for use in the processing.

Under the above-mentioned environment, the CPU 150 reads out the noise suppression program 170a from the HDD 170 to be loaded to the RAM 180 As a result, as illustrated in FIG. 15, the noise suppression program 170a functions as a noise suppression process 180a. The noise suppression process 180a loads various types of data read from the HDD 170 in an area allocated to the noise suppression process 180a in the storage area included in the RAM 180 and executes various types of processing using these various types of loaded data. For example, an example of the processing performed by the noise suppression process 180a includes the processing illustrated in FIGS. 12, 13, and 14 and the like. Not all the processing units described in the above-mentioned first embodiment necessarily have to operate in the CPU 150, but only a processing unit corresponding to the processing set as an execution target may be virtually implemented.

The noise suppression program 170a does not necessarily have to be initially stored in the HDD 170 or the ROM 160. For example, the noise suppression program 170a is stored in “portable physical media” such as a flexible disk called an FD, a CD-ROM, a DVD disk, a magneto-optical disk, and an IC card, which will be inserted into the computer 100. The computer 100 may obtain the noise suppression program 170a from these portable physical media and execute the program 170a. The noise suppression program 170a may be stored in another computer or server apparatus coupled to the computer 100 via a public line, the Internet, a LAN, a WAN, or the like, and the computer 100 may obtain the noise suppression program 170a from these and execute the noise suppression program 170a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a noise suppression program which causes a processor to perform processing, the processing comprising:
obtaining input sound;
detecting a cycle of power change in a non-voice segment included in the input sound;
calculating a correction amount that periodically changes and is applied to a voice segment included in the input sound based on the cycle; and
correcting power in at least the voice segment based on the correction amount.

2. The non-transitory computer-readable storage medium according to claim 1,
the detecting includes detecting the cycle of the power change based on a power spectrum obtained from a waveform of an envelope of a temporal waveform in the non-voice segment.

3. The non-transitory computer-readable storage medium according to claim 1,
the calculating includes correcting the phase of the correction amount calculated based on the cycle detected in the non-voice segment into a phase corresponding to the voice segment adjacent to the non-voice segment.

4. A noise suppression method performed by a computer, the method comprising:
obtaining input sound;
detecting a cycle of power change in a non-voice segment included in the input sound;
calculating a correction amount that periodically changes and is applied to a voice segment included in the input sound based on the cycle; and
correcting power in at least the voice segment based on the correction amount.

5. The noise suppression method according to claim 4,
the detecting includes detecting the cycle of the power change based on a power spectrum obtained from a waveform of an envelope of a temporal waveform in the non-voice segment.

6. The noise suppression method according to claim 4,
the calculating includes correcting the phase of the correction amount calculated based on the cycle detected in the non-voice segment into a phase corresponding to the voice segment adjacent to the non-voice segment.

7. A noise suppression apparatus comprising:
a memory; and
a processor coupled to the memory, the processor being configured to
execute an obtaining processing, that includes obtaining input sound,
execute a detection processing that includes detecting a cycle of power change in a non-voice segment included in the input sound;
execute a calculation processing that includes calculating a correction amount that periodically changes and is applied to a voice segment included in the input sound based on the cycle; and
execute a correction processing that includes correcting power in at least the voice segment based on the correction amount.

8. The noise suppression apparatus according to claim 7,
the detection processing includes detecting the cycle of the power change based on a power spectrum obtained from a waveform of an envelope of a temporal waveform in the non-voice segment.

9. The noise suppression apparatus according to claim 7,
the calculation processing includes correcting the phase of the correction amount calculated based on the cycle detected in the non-voice segment into a phase corresponding to the voice segment adjacent to the non-voice segment.
